(19) United States
(12) Patent Application Publication
(10) Pub. No.: US 2025/0096604 A1
(43) Pub. Date: Mar. 20, 2025

(54) Energy Harvesting Multisensor Wildfire Monitoring System

(71) Applicant: Wisconsin Alumni Research Foudation, Madison, WI (US)

(72) Inventors: Yigit Tuncel, Madison, WI (US); Umit Y. Ogras, Middleton, WI (US); Toygun Basaklar, Madison, WI (US)

(21) Appl. No.: 18/370,147

(22) Filed: Sep. 19, 2023

(51) Int. Cl. H02J 50/00; A62C 3/02; G06N 3/092

(52) U.S. Cl. CPC H02J 50/001; A62C 3/0271; G06N 3/092

(57) ABSTRACT

A remotely deployable sensor system for detecting wildfires dynamically selects sampling schedules for a set of different sensors according to a machine learning model trained to minimize differences between sensor samples and the environment while conserving harvested electrical energy.

### STATEMENT REGARDING FEDERALLY SPONSORED RESEARCH OR DEVELOPMENT

### CROSS REFERENCE TO RELATED APPLICATION

### Background of the Invention

The present invention relates to systems for monitoring wildfires and in particular to a self-sustained multisensor system providing on-site power management.

Wildfires occur naturally in many ecosystems worldwide; however, the frequency of wildfires has increased in recent years. The United States National Interagency Fire Center reports that the total burned area has doubled in the last 20 years. Devastating wildfires have far-reaching ecological, social, and economic impacts, such as the loss of human lives, homes, property, and infrastructure, as well as adverse effects on animal health and air quality.

Electric power infrastructure is particularly important in the context of wildfires because such systems can both initiate and be disabled by wildfires. The 2018 Camp Fire in California caused 85 fatalities, over $16 billion in damage, and led the power utility to bankruptcy.

Current techniques for preventing wildfires rely on various risk indexes that represent a rough likelihood of fire occurrences, such as the Wildland Fire Potential Index (WFPI), the National Fire Danger Rating System (NFDRS), and others. These indexes use meteorologic data from weather stations hundreds of miles away from the actual location of interest and thus provide poor temporal and spatial resolutions. Existing satellite and airborne wildfire detection systems collect intermittent data and significantly are unable to assess local ambient conditions such as high wind speeds or low humidity, which results in poor awareness and long detection times.

Motivated by these shortcomings, recent research has focused on energy-harvesting sensor suites that can be distributed through a forest to improve wildfire prevention and detection. Harvesting energy from the environment avoids the need for regular battery replacement.

One challenge to such systems is managing the consumption of the limited available power in an energy harvesting system. On the one hand, it is desirable that the sensors employ a high sampling rate to maximize the detection accuracy and response time when a wildfire approaches. On the other hand, high sampling rates increase energy consumption reducing the ability of the sensor suite to preserve energy for long durations (five years in some cases). Because wildfires can happen anytime, and the battery cannot be replaced easily due to remote locations, conserving energy is of high importance.

The current practice for managing energy of energy harvesting systems is to over specify the batteries and energy harvesters. However, this approach increases the cost of the system, potentially limiting a broad area distribution that would improve accuracy.

### SUMMARY OF THE INVENTION

The present invention provides remote wildfire sensors that dynamically schedule sensor acquisition times to co-optimize sensor accuracy and energy storage. This complex trade-off is handled by a machine learning algorithm trained over long event times punctuated by rare wildfires as would occur in practice. In one embodiment, the machine learning algorithm uses reinforcement learning resulting in a lightweight optimizer consistent with energy and hardware limited remote devices.

More specifically then, in one embodiment, the invention provides a sensor system for monitoring wildfire at a field location and includes an energy harvester for extracting energy from the environment to provide electrical power and an energy store communicating with the energy harvester for storing the provided electrical power. A sensor suite is also provided including multiple sensors measuring different environmental parameters and having different electrical energy demands as well as a wireless transmitter for communicating the environmental parameters to a remote fire assessment station. A power management circuit operates to read the environmental parameters and monitor energy in the energy store to schedule the power consumption of each sensor from the energy store according to a schedule provided by a model trained with a training set of environmental parameters of wildfires and harvestable power over multiple predefined episodes.

It is thus a feature of at least one embodiment of the invention to manage a complex trade-off between data accuracy and power consumption to maximize the collection of important wildfire related data over an extended time.

The sensors may be selected from the group consisting of, but not limited to: humidity sensors, temperature sensors, cameras, and particles sensors.

It is thus a feature of at least one embodiment of the invention to provide a sensor system that can accommodate a diverse set of sensors having different energy consumption profiles and sensitivities to different wildfire characteristics.

The episodes may extend for at least a year.

It is thus a feature of at least one embodiment of the invention to produce a sensor system that can be reliably placed in remote locations for long-term operation without failure because of lack of energy or sparse sampling that fails to rapidly detect the fire.

The model may be trained using reinforcement learning.

It is thus a feature of at least one embodiment of the invention to provide a model that can capture heuristically challenging interplay between parameter volatility associated with different sensors (how fast the sensed values change) and their relative allocated energy.

The model may be trained to provide schedules that minimize a combined difference between the environmental parameters and sensor readings of the environmental parameters over the training set.

It is thus a feature of at least one embodiment of the invention to provide a simple training metric that does not require prediction and that can produce a lightweight model suitable for remote execution on a sensing system.

Similarly, the model may be trained to provide schedules that conserve the energy stored during the episode over the training set.

It is thus a feature of at least one embodiment of the invention to co-optimize for these two interrelated features of energy consumption and accuracy which together determine the availability of reliable data.

The training set may employ a simulation of a terrain of the field location.

It is thus a feature of at least one embodiment of the invention to invest in the model static knowledge of the sensor location that can improve schedule decisions.

Similarly, the training set may provide a simulation of the climate of the field location.

It is thus a feature of at least one embodiment of the invention to further inform the model with respect to environmental factors which can influence sensor reading acquisition and energy harvesting, for example, when a photovoltaic cell is used.

The model may be created using a simulation providing simulated ground truth measurements and sensor measurements with probabilistically added noise.

It is thus a feature of at least one embodiment of the invention to provide a practical training of the sensor system with respect to multiyear timelines where the collection of actual data would be difficult.

These particular objects and advantages may apply to only some embodiments falling within the claims and thus do not define the scope of the invention.

### BRIEF DESCRIPTION OF THE DRAWINGS

FIG. 1 is a depiction of the deployment of a set of sensing systems in a wildfire area, the sensing systems providing multiple sensors and an energy harvesting system;

FIG. 2 is a block diagram of the sensing system of FIG. 1 providing an interface for receiving sensor signals, a wireless transceiver, a battery, and an energy harvesting solar panel, all controlled by a microcontroller employing a machine learning model for dynamic sensor sampling time adjustment;

FIG. 3 is a block diagram of the machine learning model providing a set of sampling times based on sensor readings and energy storage;

FIG. 4 is a block diagram of a training system for the model of FIG. 3 employing reinforcement learning; and

FIG. 5 is a diagram of sensor values showing deviation from environmental parameters being measured by virtue of sampling time decisions and noise or error.

### DETAILED DESCRIPTION OF THE PREFERRED EMBODIMENT

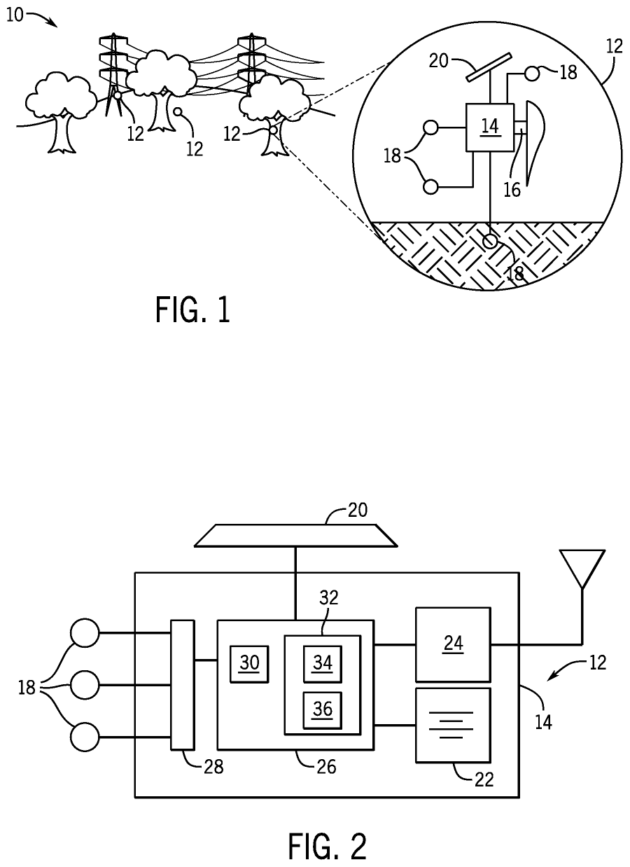

Referring now to FIG. 1, a typical sensor deployment 10 may provide for multiple sensing systems 12 distributed, for example, in a wildfire area, to monitor environmental parameters that may be used to detect or anticipate wildfires. Each sensing system 12 may provide for a field hardened housing 14, for example, including an anchor 16 for attachment of the housing 14 to a structure such as a transmission tower, tree, or ground anchor, and a weather resistant enclosure.

Circuitry within the housing 14 communicates with multiple environmental sensors 18 which may be located inside or outside of the housing 14, including but not limited to temperature sensors, particle sensors, humidity sensors, cameras, and soil moisture sensors collecting data about environmental parameters relevant to wildfires. The housing 14 may also support an energy harvester 20 such as a solar panel, thermopile, wind turbine, inductive coupling coil (for use with transmission towers) or other harvesting sources of types known in the art.

Referring now also to FIG. 2, the housing 14 may support an internal energy store 22 such as a battery or capacitor bank communicating with the energy harvester 20 to store energy from the energy harvester 20 and provide power to the other systems of the sensing system 12. These other systems include a wireless transceiver 24 providing cell phone communication or being part of a mesh network or the like, as well as a controller 26 and a sensor interface 28, the latter communicating with and providing power to the various sensors 18 as needed. As is understood in the art, the controller 26 may provide for one or more computer processors 30 communicating with an electronic memory 32, the latter holding a stored program 34 and a machine learning model 36 as will be discussed below.

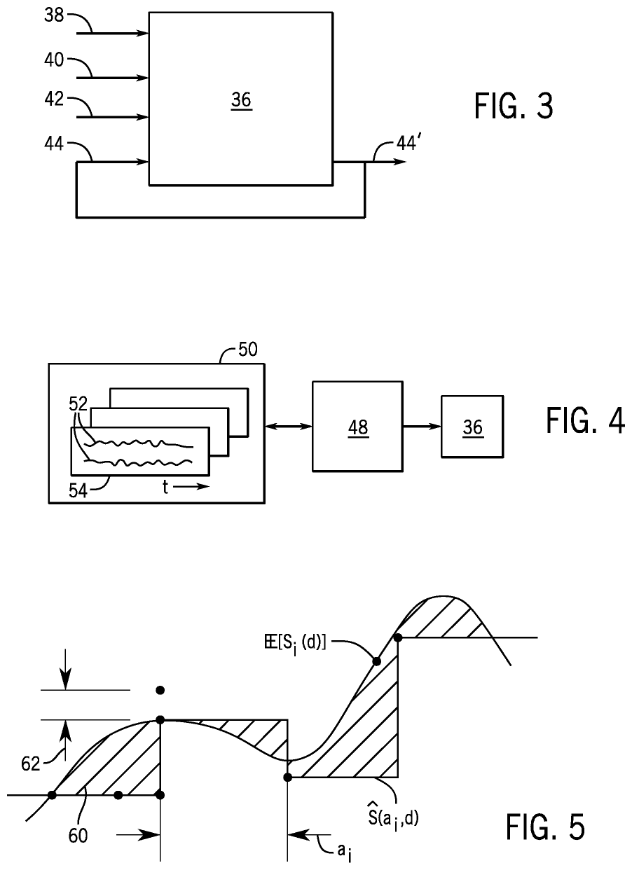

Referring now also to FIG. 3, the machine learning model 36 will receive inputs on regular time steps, for example, every hour, including a measurement of current storage energy 38 obtained, for example, by monitoring voltage of the energy store 22 and the amount of harvested energy 40 during a previous time step. This information is used to internally develop a cumulative harvested energy during a predetermined episode, for example, one year. The initial battery energy level at the beginning of the episode and the target battery energy level are also provided, this latter value being an objective that may affect how long the system can continue to run without depleting the battery and decreasing the monitoring error.

The machine learning model 36 may also receive current measured values from the sensors 18 which are used to produce a moving average of sensor readings over previous time steps (for example, 5 previous time steps) and their current sampling schedule 44 indicating a time between samples (which may differ for each sensor 18).

This information received by the machine learning model 36 is used to produce a new sampling schedule 44′ on each time step. Generally, the new sampling schedule 44′ provides a set of sampling times influenced not only by the current energy in the energy store 22 (thus being sensitive to declining or increasing energy) but also by the change in the sensor values, so that more volatile sensor values can promote a greater sampling speed and hence greater accuracy and faster wildfire detection. Importantly, the new sampling schedule 44′ produced for a given sensor 18 will be influenced by the schedules of other sensors 18, thus implicitly implementing a complex trade-off between different sensor power consumption and sampling time needs.

The new sampling schedule 44′ is used during the following time step to activate on a periodic basis the different sensors 18 to collect environmental parameter data through the interface 28 to be transmitted by transceiver 24. Significantly, the model 36 does not require prediction although prediction maybe implicit in the training as will be described below.

Referring now to FIG. 5, the model 36 may employ a reinforcement learning program 48, a form of unsupervised machine learning in which a model is trained using a training set 50 and a reward function. The reinforcement learning may use, for example, a Twin Delay Deep Deterministic Policy Gradient described at Fujimoto, H. Hoof, and D. Meger, “Addressing function approximation error in actor-critic methods,” In International conference on machine learning, pages 1587-1596, PMLR, 2018, which is an extension of T. P. Lillicrap et al., “Continuous control with deep reinforcement learning,” arXiv:1509.02971, 2015.

Three improvements maybe implemented on this form of reinforcement learning including (i) clipped double Q-learning, (ii) target policy smoothing, and (iii) delayed policy updates. Clipped double Q-learning uses two separate critic networks instead of one. It uses the smaller of the two Q-values to form the targets in Bellman's optimality equation and updates both critics using the loss function. Target policy smoothing adds noise to the reinforcement learning action and then clips the result to ensure that the target action remains in proximity to the actual action. Delayed policy updates the actor-network less frequently than the value network of the reinforcement learning to produce value estimates with lower variance and therefore promotes the generation of better policies.

A training set 50 for use with the reinforcement learning program 48 provides ground truth environmental data 52 for the parameters measured by each sensor 18 for a set of episodes 54, for example, from 1 to 5 years. In one embodiment, this training set 50 may be produced by using an open source wildfire simulator Cell2fire described at C. Pais, J. Carrasco, D. L. Martell, A. Weintraub, and D. L. Woodruff, Cell2fire: “A cell-based forest fire growth model to support strategic landscape management planning,” Frontiers in Forests and Global Change, 4:692706, 2021 to provide a coarse representation of fire progress reflecting underlying elevations and vegetation. This model combines information related to ambient temperature and wind data that may be derived from known climatic conditions around the sensing system 12. Fine scale environmental parameters in the neighborhood of the sensing system 12 are then generated by Fire Dynamics Simulator (FDS), a sophisticated computational fluid dynamics model of fire-driven fluid flow, to simulate the smoke particles and heat during the progression of a wildfire as described in K. McGrattan, R. McDermott, C. Weinschenk, and G. Forney, “Fire dynamics simulator, technical reference guide,” sixth edition, 2013. The simulator may randomly generate wildfires on random intervals consistent with the statistics observed in a typical wildfire environment and generally separated by long periods without wildfire. These ground truth parameter values may then be transformed into actual sensor readings by the introduction of a noise term based on an expected Gaussian distribution of sensor measurements.

In addition, the training set 50 provides energy harvesting data. In the case of the energy harvester 20 being a photovoltaic cell, such data can be developed by using W. F. Holmgren, C. W. Hansen, and M. A. Mikofski, “pvlib python: A python package for modeling solar energy systems,” Journal of Open Source Software, 3(29):884, 2018 and a model of a photocell, for example, derived from D. L. King, J. A. Kratochvil, and W. E. Boyson, “Photovoltaic array performance model,” volume 8. Citeseer, 2004.

This training set is then provided to the reinforcement learning program 48 which seeks to generally minimize:

$${\sum }_{i} \vert {\hat{S}}_{i} ( {a}_{i} , d ) - 𝔼 [ {S}_{i} ( d ) ] \vert$$

where:
Ŝᵢ(aᵢ, d) are the sensor readings from sensors 18 (indexed over i) at a distance d from the fire and at a sampling rate aᵢ; and
[symbol] [Sᵢ(d)] are the expected ground truth sensor values.

Generally, values of Ŝᵢ(aᵢ, d) will be determined for each sample rate investigated by using the value of the training set 50 at the sampling time and adding a Gaussian noise component reflecting fundamental error in physical measurements. The sensor values will be adjusted according to a model that provides, for example, exponential drop-off in sensor sensitivity with distance.

Referring now to FIG. 5, it will be seen that the error between these values 60 will be dependent on a noise offset 62 and the sampling rate aᵢ which produces greater errors with faster changes in the measured parameter changes. Nevertheless, generally faster sampling rates will consume greater power.

The above optimization is subject to the constraints of:

$${E}_{t + 1}^{B} = {E}_{t}^{B} + η {E}_{t + 1}^{H} - {E}_{t}^{C} ( a ) , t ∈ T$$

where:
Eₜ₊₁^{B} and Eₜ^{B} are the energy in the energy store 22 at the start and end of an time step, ηEₜ₊₁^{H} is the harvested energy during the time step (where q accounts for inefficiencies in energy harvesting and battery charging interfaces) and Eₜ^{C}(a) is the energy consumption of a sensor 18 for a given sampling which generally takes into account energy consumption during sampling and during a sleep state;
and

$${E}_{t}^{B} \geq {E}_{min}^{B} {E}_{t}^{B} \leq {E}_{max}^{B} {E}_{t}^{B} \geq {E}_{0}^{B}$$

where the energy of the energy store 22 must be constrained to be above a minimum value (e.g., 0%), below the maximum value (e.g., 100%), and greater than the initial charge state of the energy store 22.

The training may adopt a reward structure that penalizes energy storage that drops below the minimum and otherwise provides a reward rₜ proportional to the minimization value discussed above, for example, as:

$${r}_{t} = \{ \begin{matrix}- 100 & {E}_{t}^{B} \leq {E}_{min}^{B} \\ α ( \frac{{E}_{t}^{B} - {E}_{T}^{B}}{{E}_{max}^{B}} ) \vert {\hat{S}}_{i} ( {a}_{i} , d ) - 𝔼 [ {S}_{i} ( d ) ] \vert & otherwise\end{matrix}$$

As noted above, the state space of the resulting model 36 will include current battery energy, harvested energy in the previous time step, cumulative energy harvesting, initial battery level, target battery energy level, actions in the previous step, sensor readings in the previous step, and the moving average of sensor readings in a set of previous steps, for example, 5. Each of these state space values may be applied at each time step by the controller 26 using data collected at the measurement site and may be implemented at low power.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A sensor system monitoring wildfire at a field location, comprising:
a sensor suite including multiple sensors measuring different environmental parameters and having different electrical energy demands;
an energy harvester for extracting energy from the environment to provide electrical power;
an energy store communicating with the energy harvester for storing the provided electrical power;
a power management circuit operating to read the environmental parameters and monitor energy in the energy storage to schedule the power consumption of each sensor from the energy store according to a schedule provided by a model trained with a training set of environmental parameters of wildfires and harvestable power over multiple predefined episodes; and
a wireless transmitter for communicating the environmental parameters to a remote fire assessment station;

2. The sensor system of claim 1 wherein the sensors are selected from the group consisting of: humidity sensors, temperature sensors, cameras, and particles sensors.

3. The sensor system of claim 1 wherein the episode covers at least a year.

4. The sensor system of claim 1 wherein the model is trained using reinforcement learning.

5. The sensor system of claim 1 wherein the model is trained to provide schedules that minimize a combined difference between the environmental parameters and sensor readings of the environmental parameters over the training set.

6. The sensor system of claim 5 wherein the model is trained to provide schedules that conserve the energy stored during the episode over the training set.

7. The sensor system of claim 1 wherein the training set provides a simulation of a terrain of the field location.

8. The sensor system of claim 7 wherein the training set provides a simulation of a climate of the field location.

9. The sensor system of claim 1 wherein the model is a simulation providing ground truth measurements and sensor measurements with probabilistically added noise.

10. A method of training a sensor system of a type having:
an energy harvester for extracting energy from the environment to provide electrical power;
an energy store communicating with the energy harvester for storing the provided electrical power;
a sensor suite including multiple sensors measuring different environmental parameters and having different electrical energy demands;
a power management circuit operating to read the environmental parameters and monitor the energy store to schedule the power consumption of each sensor from the energy store according to a schedule provided by a model; and
a wireless transmitter for communicating the environmental parameters to a remote fire assessment station; the method comprising:
(a) generating a training set of environmental parameters of wildfires and harvestable power over multiple predefined episodes; and
(b) training the model using the training set to provide schedules that minimize a combined difference between the environmental parameters and sensor readings of the environmental parameters over the training set comprised of different episodes while conserving the energy stored during the episode over the training set.

11. The method of claim 10 wherein the sensors are selected from the group consisting of: humidity sensors, temperature sensors, cameras, and particles sensors.

12. The method of claim 10 wherein the episode covers at least a year.

13. The method of claim 10 wherein the model is trained using reinforcement learning.

14. The method of claim 10 wherein the training set provides a simulation of a terrain of a location of the sensor system.

15. The method of claim 14 wherein the training set provides a simulation of a climate of the field location.

16. The method of claim 10 wherein the model is a simulation providing ground truth measurements and sensor measurements with probabilistically added noise.
